(19) United States
(12) Patent Application Publication
(10) Pub. No.: US 2007/0025297 A1
(43) Pub. Date: Feb. 1, 2007

(54) Apparatus and method for processing vertical handoff in a wireless communication system

(75) Inventors: Sung-Jin Lee, Seoul (KR); Jung-Je Son, Seongnam-si (KR); Pan-Yuh Joo, Seoul (KR); Jun-Young Jung, Yongin-si (KR); Chong-Kwon Kim, Seoul (KR); Jiwoong Jeong, Seoul (KR)

Correspondence Address: DILWORTH & BARRESE, LLP, 333 EARLE OVINGTON BLVD., UNIONDALE, NY, 11553, US

(73) Assignees: Samsung Electronics Co., Ltd., Suwon-si (JP); Seoul National University Industry Foundation, Seoul (KR)

(21) Appl. No.: 11/493,488

(22) Filed: Jul. 26, 2006

(30) Foreign Application Priority Data
Jul. 26, 2005 (KR) 2005-0067760

(51) Int. Cl. H04Q 7/00; H04L 12/56

(52) U.S. Cl. 370/331; 370/395.21

(57) ABSTRACT

An apparatus and method for processing a vertical handoff between a WLAN and a broadband wireless communication network are provided. In a method of processing a vertical handoff in a handoff processor having a mapping table in which QoS information for the broadband wireless communication network is mapped to QoS information for the WLAN, QoS information about an STA received from a source network is converted to QoS information suitable for a target network, referring to the mapping table. A message containing the converted QoS information is generated and sent to the target network.

### PRIORITY

This application claims priority under 35 U.S.C. § 119 to an application entitled “Apparatus and Method for Processing Vertical Handoff in a Wireless Communication System” filed in the Korean Intellectual Property Office on Jul. 26, 2005 and assigned Serial No. 2005-67760, the contents of which are incorporated herein by reference.

### BACKGROUND OF THE INVENTION 1. Field of the Invention

The present invention relates generally to an apparatus and method for processing handoff between heterogeneous networks, i.e. vertical handoff in a wireless communication system, and in particular, to an apparatus and method for processing handoff between an Institute of Electrical and Electronics Engineers (IEEE) 802.11 network and an IEEE 802.16 network.

2. Description of the Related Art

Provisioning of services with diverse Quality of Service (QoS) levels at about 100 Mbps is an active research area for a future-generation communication system, namely, a 4^{th} Generation (4G) communication system. The existing 3G communication systems support about 384 kbps outdoors, i.e. in a relatively bad channel environment and up to 2 Mbps indoors, i.e. in a relatively good channel environment. Wireless Local Area Network (WLAN) and Wireless Broadband (WiBro) systems typically support 20 to 50 Mbps. In this context, studies are actively being conducted on guaranteeing of mobility and QoS for WLAN and WiBro supporting relatively high data rates in the 4G communication system.

One of such studies is handoff between heterogeneous networks, such as WLAN and WiBro (or broadband wireless communication system) systems. While in general, handoff refers to handoff between homogeneous networks, starting with the efforts with which the IEEE 802.21 working group is developing standards to enable handoff between heterogeneous networks, the inter-technology handoff will be provided seamlessly in 4G.

The IEEE 802.11 Task Group (TG) f is working on support of handoff between IEEE 802.11 Access Points (APs) and the IEEE 802.11 standards define only handoff-associated messages. Typically, the cell coverage of an IEEE 802.11 network is tens to hundreds of meters, and that of an IEEE 802.16 network reaches a few kilometers. Thus, it is meaningless to separate the two networks. The IEEE 802.11 APs are expected to increase the capacity of IEEE 802.16 Base Stations (BSs) or cover shadowing areas that the 802.16 BSs cannot cover. The IEEE 802.11 network will be integrated into the IEEE 802.16 network rather than into a network that is configured by separating them.

A description will be made below of a conventional handoff between a WLAN and a broadband wireless communication network.

The terms used herein “handoff between homogeneous networks” and “horizontal handoff” are interchangeably used as having the same meaning, and “handoff between heterogeneous networks” and “vertical handoff” are also interchangeably used as having the same meaning. In addition, the IEEE 802.11 network and the IEEE 802.16 network are called “WLAN” and “broadband wireless communication network”, respectively.

Horizontal Handoff between APs in the IEEE 802.11 System

As described above, the IEEE 802.11 TG f specifies simple messages for handoff between APs. A Station (STA) shall initiate a handoff according to the IEEE 802.11f draft. A reassociation request message and a reassociation response message are defined to support handoff in the IEEE 802.11 standard. The reassociation request message further includes an old AP field in addition to an association request message, and the reassociation response message is identical to an association response message.

In the handoff procedure as provided by the IEEE 802.11f draft, the STA dissociates from an old AP and reassociates with a new AP. The IEEE 802.11f defines an Inter-Access Point Protocol (IAPP) which defines messages exchanged between APs, for handoff. Such IAPP messages include IAPP ADD-notify, IAPP MOVE-notify, and IAPP MOVE-response.

FIG. 1 illustrates a conventional handoff procedure in an IEEE 802.11 WLAN.

Referring to FIG. 1, an STA 180 associates with a first AP 150 by association request and response messages in step 111. The first AP 150 sends an IAPP ADD-notify message to a Remote Authentication Dial-In User Service (RADIUS) server 110, notifying the entry of the STA 180 into the first AP 150 in step 113. The RADIUS server 110 multicasts the IAPP ADD-notify message to APs within the same domain in step 115. It is assumed that a second AP 170 is located in the same domain.

When the STA 180 moves to the second AP 170, i.e. a handoff to the second AP 170 is requested in step 117, it sends a reassociation request message to the second AP 170 and receives a reassociation response message for the reassociation request from the second AP 170 in step 119.

As the STA 180 has associated with the second AP 170, the second AP 170 sends an IAPP MOVE-notify message to the first AP 150 via the RADIUS server 110 in step 121. The first AP 150 dissociates from the STA 180 in step 123 and sends an IAPP MOVE-response message including information about a requested context to the second AP 170 via the RADIUS server 110 in step 125. In this way, the handoff to the second AP 170 is completed.

QoS Support in the IEEE 802.11e System

The IEEE 802.11e standard defines a Medium Access Control (MAC) protocol or a MAC protocol layer for application programs requiring QoS such as voice and video.

In the IEEE 802.11e MAC protocol, two channel access mechanisms are proposed: Enhanced Distributed Channel Access (EDCA) and Hybrid Coordination Function (HCF) Controlled Channel Access (HCCA).

EDCA prioritizes traffic by introducing four different Access Categories (ACs) to each STA. Each AC maintains a separate transmit queue and InterFrame Space (IFS), and hence a higher-prioritized queue has a smaller IFS and a resulting small transmission delay. In the STA, a virtual collision handler resolves internal collision between different ACs so that collision occurs only in lower-prioritized queues. A QoS mechanism for probability-based bandwidth distribution to traffic categories may be provided.

HCCA is a Point Coordination Function (PCF)-like polling-based method. A Hybrid Coordinator (HC) allocates time and a bandwidth to an STA by polling based on a Traffic Specification (TSPEC). HCCA can guarantee QoS perfectly through appropriate scheduling and admission control, relative to EDCA. An IEEE 802.11e AP supporting QoS is called a QoS AP (QAP) and the HC resides in the QAP. An STA for which QoS is supported is called a QoS STA (QSTA).

Setup of a Traffic Stream (TS) and a TSPEC involved in the TS setup in the 802.11e communication system will be described below.

TS Setup in the IEEE 802.11 System

FIG. 2 is a diagram illustrating a signal flow for setting up a TS in a typical IEEE 802.11 system.

Referring to FIG. 2, a Station Management Entity (SME) 210 of a QSTA sends a MAC subLayer Management Entity (MLME)-ADDTS.request message to a MAC layer 230 of the QSTA, requesting setup of a TS in step 211. The MAC layer 230 activates an ADDTS timer in step 213 and sends an ADDTS QoS Action request message to an HC MAC layer 250 of a QAP in step 215.

The HC MAC layer 250 acquires a TSPEC (i.e. QoS information) from the ADDTS QoS Action request message and transfers an MLME-ADDTS.indication message including the QoS information to a higher layer, i.e. an HC SME 270 in step 217. The HC SME 270 replies to the HC MAC layer 250 with an MLME-ADDTS.response in step 219. Then the HC MAC layer 250 sends an ADDTS QoS Action Response message to the STA MAC layer 230 in step 221.

The STA MAC layer 230 stops the ADDTS timer in step 225 and sends an MLME ADDTS.confirm message to a higher layer, i.e. the STA SME 210, thereby completing the TS setup.

The MLME-ADDTS.request message that the QSTA sends to the QAP and the MLME-ADDTs.response message which the QAP replies to the QSTA contains a TSPEC element for supporting QoS.

Table 1 and Table 2 below illustrate the structures of the MLME-ADDTS.request message and the MLME-ADDTs.response message, respectively.

TABLE 1

| Information | Notes |
|---|---|
| Category | Set to ‘1’ to indicate QoS |
| Action | Set to ‘0’ to indicate ADDTS request |
| Dialog Token | TSPEC parameter provided by MLME |
| TSPEC | Refer to Table 3 |
| TCLAS (optional) | TSPEC parameter provided by MLME |
| TCLAS Processing (optional) | TSPEC parameter provided by MLME |

TABLE 2

| Information | Notes |
|---|---|
| Category | Set to ‘1’ to indicate QoS |
| Action | Set to ‘1’ to indicate ADDTS response |
| Dialog Token | TSPEC parameter provided by MLME |
| Status Code | Status code |
| TS Delay | Waiting time information before TS |
| | reinitiation |
| TSPEC | Refer to Table 3 |
| TCLAS (optional) | TSPEC parameter information provided |
| | by MLME |
| TCLAS Processing (optional) | TSPEC parameter information provided |
| | by MLME |
| Schedule | Service action time and interval |

The TSPEC element contains the set of parameters that define the characteristics and QoS expectations of a traffic flow. The structure of the TSPEC element is defined in Table 3 below. Thus, a TS is identified by combining a TSPEC and a TS Identification (ID).

TABLE 3

| Information | Notes |
|---|---|
| Element ID | ID of the element |
| Length | Length of the element |
| TS info | Refer to Table 4 |
| Nominal MSDU size | MSDU size |
| Maximum MSDU size | Maximum MSDU size |
| Minimum Service Interval | Minimum interval between the starts of two |
| | successive service periods |
| Maximum Service Interval | Maximum interval between the starts of two |
| | successive service periods |
| Service Start Time | Time when the service period starts, |
| | expressed in microseconds |
| Minimum Data Rate | Allowed lowest data rate |
| Mean Data Rate | Allowed mean data rate |
| Peak Data Rate | Allowed highest data rate |
| Maximum Burst Size | Maximum burst of MSDUs that arrive at the |
| | MAC SAP |
| Delay Bound | Maximum amount of time allowed to |
| | transport MSDU |
| Medium Time | Grant time for EDCA access |

The structure of the TS info field is defined in Table 4:

TABLE 4

| Information | Notes |
|---|---|
| Traffic Type | Periodic traffic pattern |
| TSID | ID of the TS |
| Direction | Direction of traffic (uplink or downlink) |
| Access Policy | Channel access policy such as HCCA or EDCA |
| Aggregation | Indicates whether frame aggregation is used |
| APSD | Indicates whether automatic power save delivery is |
| | used |
| User Priority | Relative prioritization within the same traffic |
| TSInfo Ack Policy | Ack Policy such as Normal Ack, no Ack, and Block |
| | Ack |
| Schedule | Indicates whether scheduling is used in case of |
| | EDCA |

Horizontal Handoff between BSs in the IEEE 802.16 System

In the IEEE 802.16 network, initialization between a BS and an STA complies with the IEEE 802.16-2004 standard, and horizontal handoff is implemented in compliance with the IEEE 802.16e draft.

FIG. 3 is a flowchart illustrating a handoff procedure in a Mobile Subscriber Station (MSS) in a conventional IEEE 802.16 broadband wireless communication network.

Referring to FIG. 3, at an initialization or when a signal is disconnected from a BS, an MSS selects a cell (or BS) to camp on by downlink channel scanning in step 301. For example, the MSS scans successive downlink channels starting with the latest received channel until it receives a valid downlink signal.

After the cell selection, the MSS acquires physical synchronization using the preamble of a downlink frame received from the selected BS in step 303. If Downlink-Medium Access Protocol (DL-MAC) and Downlink Channel Descriptor (DCD) messages are received successfully, it is considered that synchronization with the BS has been acquired.

The MSS receives Uplink Channel Descriptor (UCD) information from the BS and acquires uplink parameters from the UCD information in step 305. If it is determined based on the uplink parameters that the uplink is not available to the MSS, the MSS starts channel scanning for another channel. On the contrary, if the uplink is available, the MSS waits for the next DL-MAP and UL-MAP and checks an initial ranging area (or resources) allocated by the BS.

In step 307, the MSS performs ranging. Specifically, the MSS sends an RNG-REQ (ranging request) message to the BS according to the initial ranging area. The MSS initially sends the RNG-REQ (ranging request) message at a minimum power level and if it does not receive a response from the BS, it increases the power level gradually. The BS replies to the RNG-REQ message with RNG-RSP, allocates a Connection ID (CID) to the MSS, and allocates an individual initial ranging area for correcting a transmission power level and a timing offset to the MSS.

The MSS then exchanges RNG-REQ and RNG-RSP with the BS through the individual initial ranging area, thereby adjusting the transmission power and timing.

After the ranging, the MSS negotiates basic capabilities with the BS by exchanging SS Basic Capability Request (SBC-REQ) and SS Basic Capability Response (SBC-RSP) messages in step 309.

In step 311, the MSS performs authorization and exchanges keys. The MSS then associates with the BS by exchanging Registration Request (REG-REQ) and Registration Response (REG-RSP) messages with the BS in step 313.

After the registration, the MSS establishes an Internet Protocol (IP) connection in step 315. That is, the MSS negotiates an IP version that the BS supports, is allocated an IP address by a Dynamic Host Configuration Protocol (DHCP) mechanism, and receives a date and time for the time stamp of log files. In step 317, the MSS sends operational parameters to the BS. It is noted that steps 315 and 317 are optional.

When the initialization procedure is completed in this way, the MSS establishes a connection in step 319 and operates normally by the connection in step 321. During normal operation, the MSS searches neighbor BSs by channel scanning at predetermined intervals in step 323.

If a handoff is decided, the MSS terminates the existing connection from the old BS (or source BS) in step 327 and selects a target BS in step 329.

In steps 331, 333 and 335, the MSS performs a new network entry for the target BS in a similar manner to the above-described initialization procedure. The new network entry is the process of searching for a cell offering a high Signal-to-Interference plus Noise Ratio (SINR) without association, before normal registration to the cell. Hence, the old BS does not find out the movement state of the MSS.

When finally deciding on the target BS, the MSS performs re-authorization in step 337 and carries out re-registration and re-establishes service flows in step 339. Thus, the MSS associates with the target BS. In step 341, the MSS operates normally by the connection to the new BS. Meanwhile, the MSS may re-establish an IP connection in step 343. In case of a “make-before-break” handoff, the MSS terminates every connection from the old BS in step 345.

FIG. 4 is a diagram illustrating a signal flow for a conventional overall handoff procedure in the IEEE 802.16 broadband wireless communication network. While handoff initiation may occur in both the BS and the MSS, the MSS initiates a handoff in the illustrated case of FIG. 4.

Referring to FIG. 4, an MSS 410 acquires neighbor BSs 470 and 490 by frequency channel scanning and determines whether to implement a handoff by measuring received signal strengths from the neighbor BSs 470 and 490. If the MSS 410 decides on a handoff, it sends a MOB_MSSHO-REQ message including information about the neighbor BSs 470 and 490 as candidate target BSs to a serving BS 450. The structure of MOB_MSSHO-REQ is defined in Table 5.

TABLE 5

| Information | Notes |
|---|---|
| Management Type | ID (57) identifying MOB_MSSHO-REQ |
| N_Recommended | Number of BSs that MSS sets as candidates |
| Each Candidate BS | BS ID, preamble index, SINR, etc. |
| Information | |
| Message Authentication | MAC ensuring integrity |
| Code (MAC) | |

Upon receipt of MOB_MSSHO-REQ, the serving BS 450 sends a HO-pre-notification message to the candidate BSs 470 and 490, notifying the handoff of the MSS 410 in steps 413 and 415. Simultaneously, the serving BS 450 informs them of the MSS ID, connection parameter, capabilities, requested BandWidth (BW), and QoS information of the MSS 410. In steps 417 and 419, the candidate BSs 470 and 490 send an ACKnowledgement (Ack) in a HO-pre-notification-response message to the serving BS 450.

The serving BS 450 determines a target BS based on information (e.g. QoS) included in the HO-pre-notification-response message. It is assumed herein that the BS 490 is chosen as the target BS. The serving BS 450 then sends an HO-confirm message to the target BS 490 in step 421 and notifies the MSS 410 of the target BS 490 in a MOB_BSHO-RSP message in step 423. The present IEEE 802.16e draft has not yet specified the message format of HO-pre-notification. MOB_BSHO-RSP has the following format shown in Table 6.

TABLE 6

| Information | Notes |
|---|---|
| Management Type | ID (58) identifying MOB_BSHO-RSP |
| N_Recommended | Number of BSs that MSS sets as candidates |
| Each Candidate BS | Store BS ID, preamble index, HO process |
| Information | optimization information in BS-recommended |
| | order |
| New_BS Information | Information about BS that serving BS |
| | recommends among BSs that MSS has not |
| | selected as candidates |
| Message Authentication | MAC ensuring integrity |
| Code (MAC) | |

In step 425, the MSS 410 notifies the serving BS 450 of normal handoff completion in MOB_HO-IND. The serving BS 450 releases resources and a connection from the MSS 410 in step 427. The MSS 410 may cancel the handoff or reject a handoff recommended by the serving BS 450 by a predetermined field of the MOB_HO-IND message.

In step 429, the MSS performs fast ranging based on known information about the target BS 490. The MSS 410 then enters a new network in steps 431 and 433, in the manner described with reference to FIG. 3. MOB_HO-IND is configured as follows as shown in Table 7.

TABLE 7

| Information | Notes |
|---|---|
| Management Type | ID (59) identifying MOB_HO-IND |
| HO-IND_type | Indicates one of serving BS release, HO cancel, |
| | and HO reject |
| Message Authentication | MAC ensuring integrity |
| Code (MAC) | |

QoS Support in the IEEE 802.16 System

The IEEE 802.16e system supports QoS through scheduling. An explicit QoS is provided for each uplink traffic flow so that the BS can estimate a throughput and delay for the uplink traffic and send a poll or grant at an appropriate point of time. For QoS guarantee, IEEE 802.16 defines four service classes: Unsolicited Grant Service (UGS), real-time Polling Service (rtPS), non-real-time Polling Service (nrtPS), and Best Effort Service (BES). IEEE 802.16 utilizes piggybacking and bandwidth stealing polling to send requests to the BS for transmission opportunities on the uplink channel.

UGS is designed to support real-time uplink service flows that transport fixed-size data packets on a periodic basis. Hence, UGS offers a fixed bandwidth periodically and resource allocation is ensured without any contention or request. rtPS and nrtPS allocate bandwidth basically through polling. rtPS offers periodic unicast polls without any contention to guarantee QoS for real-time traffic, whereas nrtPS allocates bandwidth by contention as well as unicast polls.

Main parameters for each traffic type (i.e. service type) are listed in Table 8.

TABLE 8

| Scheduling type | Information elements |
|---|---|
| UGS | SDU size |
| | Unsolicited Grant Interval |
| | Tolerated Jitter |
| | Request/Transmission Policy |
| | Minimum Reserved Traffic Rate |
| | Maximum Latency |
| rtPS | Minimum Reserved Traffic Rate |
| | Maximum Latency |
| | Maximum Sustained Traffic Rate |
| | Unsolicited Polling Interval |
| | Traffic Priority |
| | Request/Transmission Policy |
| nrtPS | Minimum Reserved Traffic Rate |
| | Maximum Sustained Traffic Rate |
| | Request/Transmission Policy |
| | Traffic Policy |
| BES | Maximum Sustained Traffic Rate |
| | Traffic Policy |
| | Request/Transmission Policy |

The above parameters are defined in Table 9 below.

TABLE 9

| Information | Notes |
|---|---|
| SDU size | Length of Service Data Unit (SDU), |
| | default = 49 bytes |
| Unsolicited Grant Interval | Nominal interval between successive |
| | data grants |
| Tolerated Jitter | Allowed maximum delay variation in ms |
| Request/transmission Policy | Indicates whether Broadcast, new request |
| | piggyback, packet fragmentation, and |
| | CRC are used |
| Minimum Reserved Traffic | Minimum reserved data rate for service |
| Rate | flow |
| Maximum Latency | Maximum latency between packet |
| | receptions |
| Maximum Sustained Traffic | Maximum data rate for service flow |
| Rate | except MAC overhead |
| Unsolicited Polling Interval | Nominal interval between successive |
| | polling grants |
| Traffic Priority | Priority assigned to service flow |

As described above, although the present IEEE 802.11 and IEEE 802.16 standards define handoff between homogeneous networks, vertical handoff between the IEEE 802.11 and IEEE 802.16 networks is yet to be specified. The IEEE 802.11 APs will increase the capacity of the IEEE 802.16 BSs or cover shadowing areas that the 802.16 BSs cannot cover. The integration of the IEEE 802.11 network into the IEEE 802.16 network requires an efficiency handoff technique between the two networks. As stated before, both IEEE 802.11 and IEEE 802.16 support QoS and accordingly, there exists a need for developing a technique for implementing seamless vertical handoff with QoS guarantee.

### SUMMARY OF THE INVENTION

An object of the present invention is to substantially solve at least the above problems and/or disadvantages and to provide at least the advantages below. Accordingly, an object of the present invention is to provide an apparatus and method for processing vertical handoff in a wireless communication system.

Another object of the present invention is to provide an apparatus and method for processing handoff between IEEE 802.11 and IEEE 802.16 networks in a wireless communication system.

A further object of the present invention is to provide an apparatus and method for processing vertical handoff, while taking QoS into account in a wireless communication system.

Still another object of the present invention is to provide an apparatus and method for processing handoff between IEEE 802.11 and IEEE 802.16 networks, while taking QoS into account in a wireless communication system.

The above objects are achieved by providing an apparatus and method for processing a vertical handoff between a WLAN and a broadband wireless communication network.

According to one aspect of the present invention, in a method of processing a vertical handoff in a handoff processor having a mapping table in which QoS information for a broadband wireless communication network is mapped to QoS information for a WLAN, QoS information about an STA received from a source network is converted to QoS information suitable for a target network, referring to the mapping table. A message containing the converted QoS information is generated and sent to the target network.

According to another aspect of the present invention, in a method of processing a vertical handoff in a handoff processor having a mapping table in which QoS information for a broadband wireless communication network is mapped to QoS information for a WLAN, upon receipt of a vertical handoff request message from a BS of the broadband wireless communication network, QoS information is acquired from the vertical handoff request message and converted to QoS information for the WLAN, referring to the mapping table. A request message containing the converted QoS information is generated and sent to an AP of the WLAN.

According to a further aspect of the present invention, in a method of processing a vertical handoff in a handoff processor having a mapping table in which QoS information for a broadband wireless communication network is mapped to QoS information for a WLAN, upon receipt of a vertical handoff request message from an AP of the WLAN, QoS information is acquired from the vertical handoff request message and converted to QoS information for the broadband wireless communication network. A request message containing the converted QoS information is generated and sent to a BS of the broadband wireless communication network.

According to still another aspect of the present invention, in a method of processing a vertical handoff in an AP in a wireless communication system having a handoff processor for supporting handoff between a WLAN and a broadband wireless communication network, upon receipt of a vertical handoff request message from an STA, a request message including QoS information about the STA is generated and sent to the handoff processor. Upon receipt of a response message for the request message from the handoff processor, BS access information is acquired from the response message. A vertical handoff response message including the acquired BS access information is sent to the STA.

According to still further aspect of the present invention, in a method of processing a vertical handoff in an AP in a wireless communication system having a handoff processor for supporting handoff between a WLAN and a broadband wireless communication network, A request message including QoS information about an STA which is to hand over from a BS of the broadband wireless communication network to the AP is received from the handoff processor. An admission control is performed using the QoS information acquired from the request message. A connection setup message for setting up a connection with the STA is sent to the STA, if it is determined that the STA is admitted.

According to yet another aspect of the present invention, in a method of processing a vertical handoff in a BS in a wireless communication system having a handoff processor for supporting handoff between a WLAN and a broadband wireless communication network, a request message including QoS information about an STA which is to hand over from an AP of the WLAN to the BS is received from the handoff processor. An admission control is performed using the QoS information acquired from the request message. A message including BS access information is generated and sent to the handoff processor, if it is determined that the STA is admitted.

According to yet further aspect of the present invention, in a method of processing a vertical handoff in an STA connected to an AP in a wireless communication system having a handoff processor for supporting handoff between a WLAN and a broadband wireless communication network, a signal is acquired from a neighbor BS. It is determined whether to perform a vertical handoff based on the signal from the BS. If it is determined that the vertical handoff is to be performed, a vertical handoff request message is sent to the AP. Upon receipt of a message including the BS access information from the AP, a connection is established with the BS using BS access information.

According to still yet another aspect of the present invention, in a method of processing a vertical handoff in an STA connected to a BS in a wireless communication system having a handoff processor for supporting handoff between a WLAN and a broadband wireless communication network, a signal is acquired from a neighbor AP by scanning. It is determined whether to perform a vertical handoff based on the signal from the AP. If it is determined that the vertical handoff is to be performed, a vertical handoff request message is sent to the BS. Upon receipt of a connection setup message from the AP, a connection is established with the AP.

According to further yet another aspect of the present invention, in an apparatus for processing a vertical handoff between a WLAN and a broadband wireless communication network, a memory has a mapping table in which QoS information for the broadband wireless communication network is mapped to QoS information for the WLAN. A controller converts QoS information about an STA received from a source network to QoS information for a target network, referring to the mapping table, during a vertical handoff of the STA.

### BRIEF DESCRIPTION OF THE DRAWINGS

The above and other objects, features and advantages of the present invention will become more apparent from the following detailed description when taken in conjunction with the accompanying drawings in which:

FIG. 1 illustrates a conventional handoff procedure in an IEEE 802.11 WLAN;

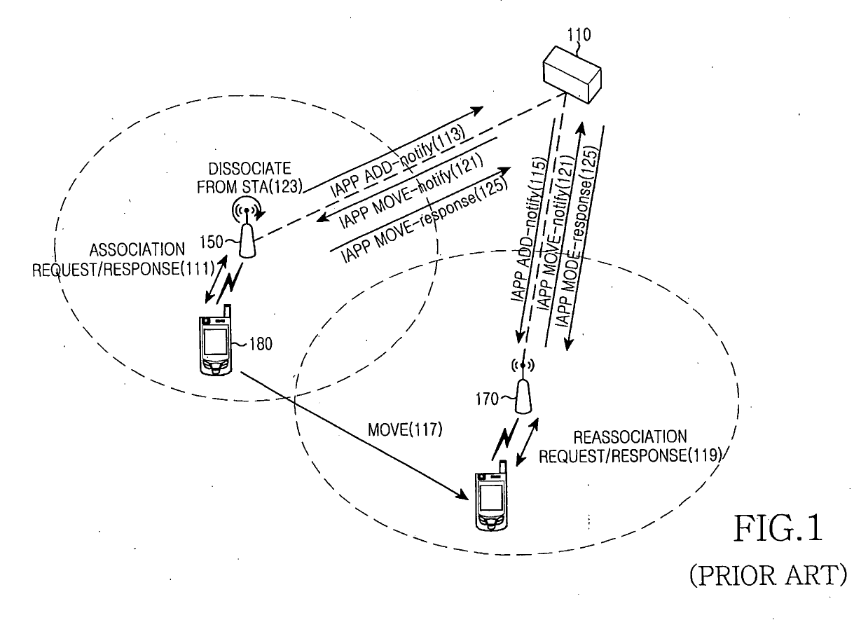

FIG. 2 is a diagram illustrating a TS setup procedure in a typical IEEE 802.11 system;

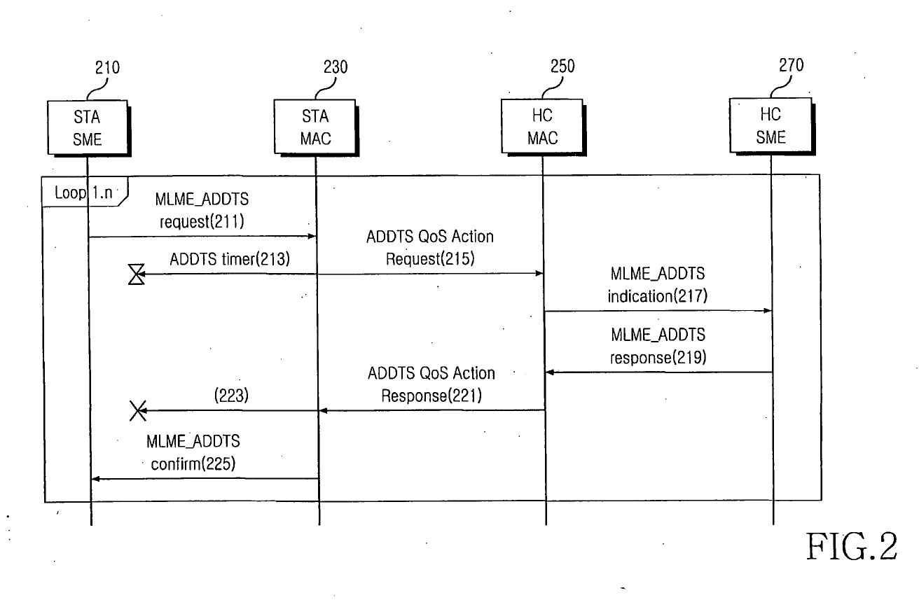

FIG. 3 is a flowchart illustrating a conventional handoff procedure in an MSS in an IEEE 802.16 broadband wireless communication network;

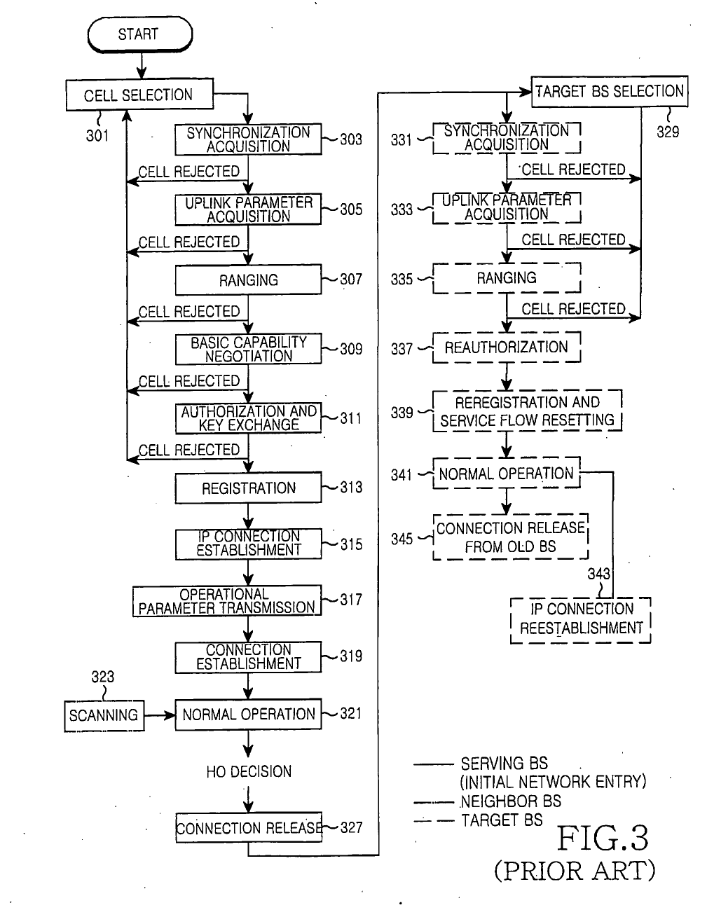

FIG. 4 is a diagram illustrating a signal flow for a conventional overall handoff procedure in the IEEE 802.16 broadband wireless communication network;

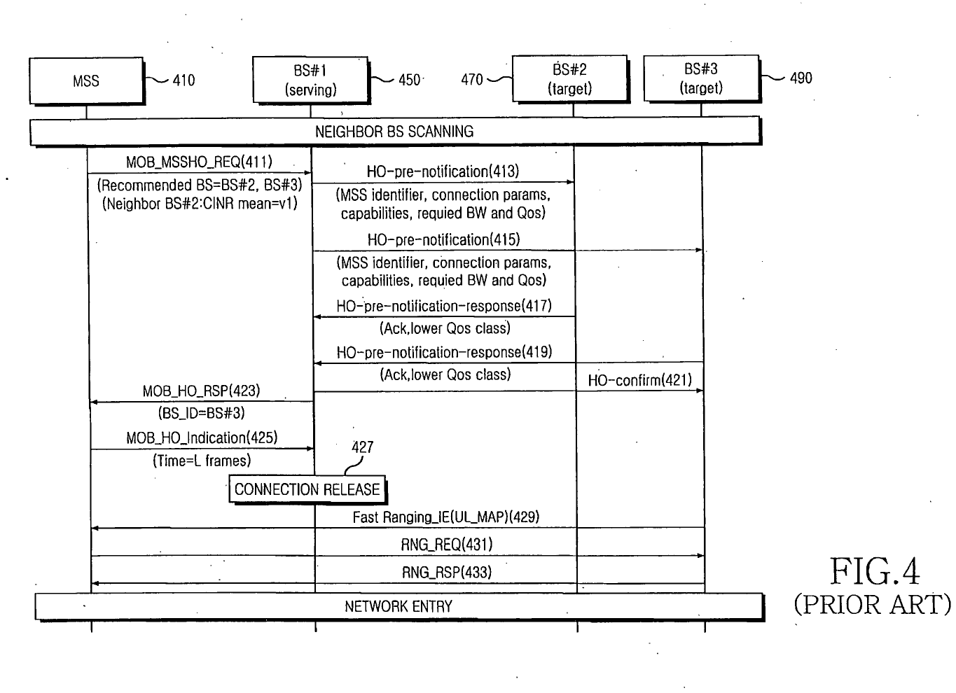

FIG. 5 illustrates a system model according to the present invention;

FIG. 6 illustrates a procedure for performing a vertical handoff from a broadband wireless network (an IEEE 802.16 network) to a WLAN (an IEEE 802.11 network) according to the present invention;

FIG. 7 is a detailed block diagram of a handoff processing entity according to the present invention;

FIG. 8 is a flowchart illustrating a handoff procedure in the handoff processing entity according to the present invention;

FIG. 9 is a diagram illustrating a signal flow for the vertical handoff from the broadband wireless network to the WLAN according to the present invention; and

FIG. 10 is a diagram illustrating a signal flow for a vertical handoff from the WLAN to the broadband wireless network according to the present invention.

### DETAILED DESCRIPTION OF THE PREFERRED EMBODIMENTS

Preferred embodiments of the present invention will be described herein below with reference to the accompanying drawings. In the following description, well-known functions or constructions are not described in detail since they would obscure the invention in unnecessary detail.

A detailed description will be made below of vertical handoff between an IEEE 802.16 network and an IEEE 802.11 network, taking into account QoS according to the present invention.

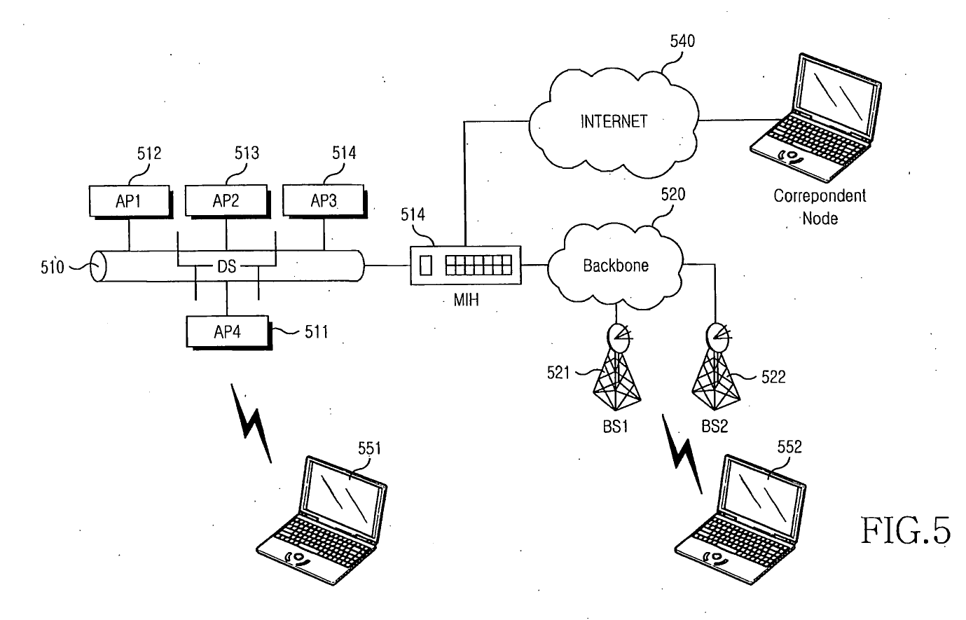

FIG. 5 illustrates a system model according to the present invention.

Referring to FIG. 5, APs 511 to 514 are mutually connected through a Distribution System (DS) 510 in an IEEE 802.11 network, and BSs 521 and 522 are connected to an IEEE 802.16 backbone network 520 in an IEEE 802.16 network.

A Media Independent Handover (MIH) entity 530 (hereinafter, referred to as a handoff processing entity 530) is responsible for interworking among the IEEE 802.11 network 510, the IEEE 802.16 network 520, and a wired network (i.e. Internet) 540. The handoff processing entity 530 manages information about STAs 551 and 552 connected to the APs 511 to 514 and the BSs 521 and 522, such as MAC and IP addresses, and controls handoff between a BS and an AP based on the STA information. It is assumed herein that the STAs 551 and 552 are dual-mode STAs capable of communicating with an IEEE 802.11 AP and an IEEE 802.16 BS. When a new STA associates with one of the APs 511 to 514 or one of the BSs 521 and 522, information about the STA is provided to the handoff processing entity 530 by a new defined message or by overheadering an existing registration message.

The handoff processing entity 530 functions to convert/relay handoff messages between the IEEE 802.11 and IEEE 802.16 networks in order to support vertical handoff between the two networks. The handoff processing entity 530 also converts/relays QoS information between the IEEE 802.11 and IEEE 802.16 networks. Since a consideration is given to QoS, seamless vertical handoff can be implemented according to the present invention. A mapping table for mapping different QoS parameters from the heterogeneous networks is constructed, such as shown in Table 10 below.

TABLE 10

| IEEE 802.16 QoS parameters | | IEEE 802.11 QoS parameters |
|---|---|---|
| SDU size | [symbol] | Nominal MSDU size |
| Maximum Sustained Traffic Rate | [symbol] | Peak Data Rate |
| Minimum Reserved Traffic Rate | [symbol] | Minimum Data Rate |
| Maximum Latency | [symbol] | Delay Bound |
| Unsolicited Grant/Polling Interval | [symbol] | Minimum Service Interval |
| Tolerated Jitter | [symbol] | \|(Maximum Service Interval) − |
| | | (Minimum Service |
| | | Interval)\| |
| Traffic Priority | [symbol] | User Priority |

For example, in the case of a handoff of an uplink QoS traffic flow of UGS, rtPS or nrtPS from an IEEE 802.16 BS to an IEEE 802.11 AP, the direction of TS info is uplink and Access Policy is HCCA in the IEEE 802.11 system. Not all the parameters listed in Table 10 are required to support QoS. The handoff processing entity 530 converts only received QoS information and sends the converted QoS information in a predetermined message.

In the case of an IEEE 802.16 to IEEE 802.11 handoff, if receiving SDU size (1000 bytes) and Maximum Latency (10 ms) as IEEE 802.16 QoS parameters, the handoff processing entity 530 constructs a TSPEC with Nominal MSDU size corresponding to SDU size and Delay Bound corresponding to Maximum Latency. In other words, the Nominal MSDU Size (1000 bytes) and the Delay Bound (10 ms) are inserted into the contents of the TSPEC. This TSPEC is delivered in a predetermined message (INP-REQ) to the IEEE 802.11 AP.

The handoff processing entity 530 may be configured separately as illustrated in FIG. 5, or incorporated into an IEEE 802.16 BS as an internal module in another embodiment of the present invention.

Now an IEEE 802.16-IEEE 802.11 vertical handoff procedure will be described below in detail.

A handoff is initiated differently in the IEEE 802.11 and IEEE 802.16 networks. According to the IEEE 802.11f draft, when an STA decides a handoff to a new AP by scanning, it reassociates with the new AP and the new AP sends a handoff message to the old AP, thereby completing the handoff. In IEEE 802.11, the STA always initiate a handoff and implements the handoff by communication with the new AP only.

In contrast, both the STA and the BS can initiate a handoff in IEEE 802.16. After the STA or the BS decides the handoff, the old BS processes a handoff request. Thus, before establishing a connection to the new BS, the STA releases all connections from the old BS. Accordingly, the IEEE 802.11-IEEE 802.16 vertical handoff shall be performed, considering the difference between these two technologies.

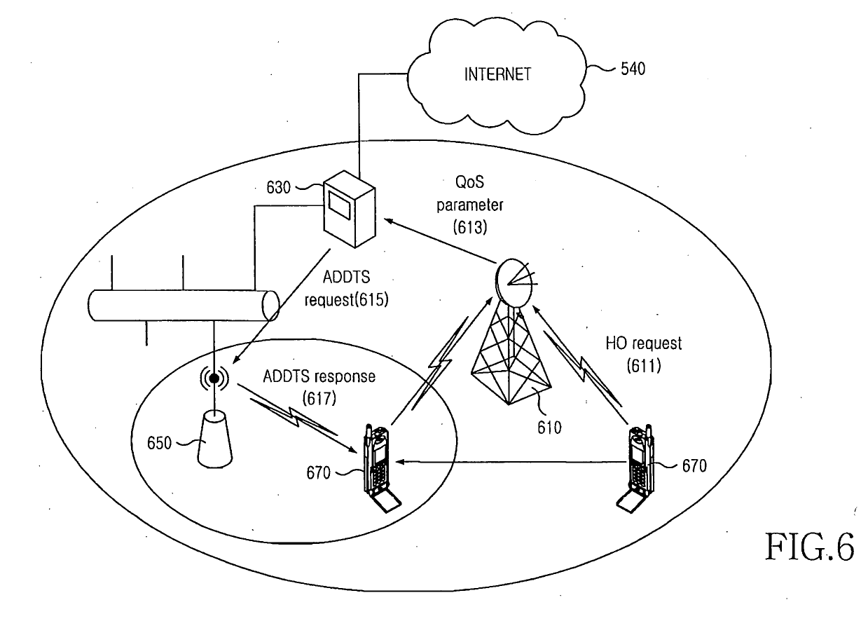

FIG. 6 illustrates a procedure for performing a vertical handoff from a broadband wireless network (an IEEE 802.16 network) to a WLAN (an IEEE 802.11 network) according to the present invention. An STA 670 performs a vertical handoff from an IEEE 802.16 BS 610 to an IEEE 802.11 AP 650.

Referring to FIG. 6, the STA 670 sends a HandOff (HO) request message to the BS 610 in step 611. Upon receipt of the HO request message, the BS 610 sends a message including QoS information of the STA 670 to a handoff processing entity 630 in step 613.

In step 615, the handoff processing entity 630 converts the received QoS information to QoS information suitable for the WLAN using a mapping table such as Table 10 and sends an ADDTS request message including the converted QoS information to the AP 650.

The AP 650 sends an ADDTS response message and a reassociation response message to the STA 670 which has moves to the coverage area of the AP 650, thereby completing the vertical handoff in step 617.

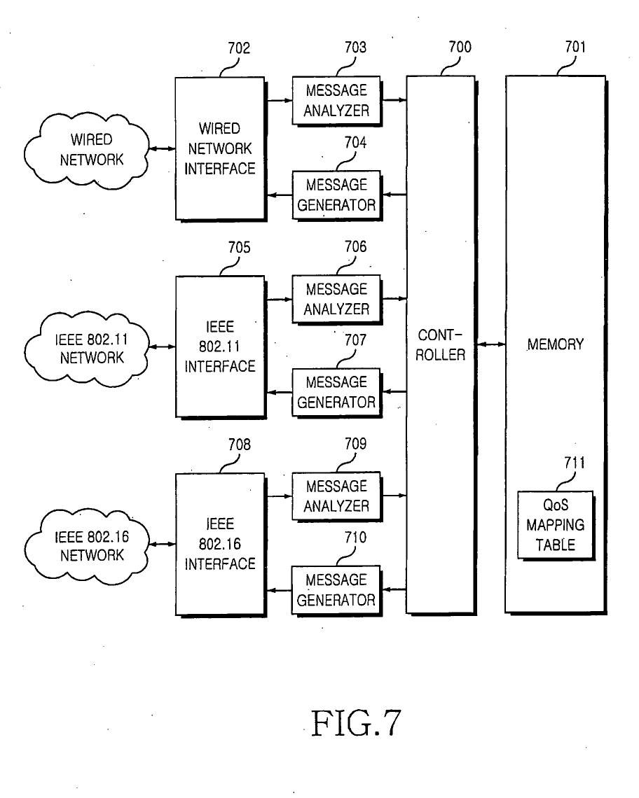

FIG. 7 is a detailed block diagram of the handoff processing entity 530 according to the present invention.

Referring to FIG. 7, the handoff processing entity 530 includes a controller 700, a memory 701, a wired network interface 702, a first message analyzer 703, a first message generator 704, an IEEE 802.11 network interface 705, a second message analyzer 706, a second message generator 707, an IEEE 802.16 network interface 708, a third message analyzer 709, and a third message generator 710.

In operation, the wired network interface 702 interfaces with the Internet. The wired network interface 702 sends an IP packet received from the Internet to the first message analyzer 703 and sends an IP packet received from the first message analyzer 703 to the Internet.

The first message analyzer 703 analyzes a wired network message or packet received form the wired network interface 702 and provides the message or packet to the controller 700. The first message generator 704 converts traffic and/or control information received from the controller 700 in the format defined by the wired network standard and sends the converted traffic and/or control information to the wired network interface 702.

The IEEE 802.11 network interface 705 interfaces with the IEEE 802.11 network. The second message analyzer 706 analyzes an IEEE 802.11 message received from the IEEE 802.11 network interface 705 and provides the message to the controller 700. The second message generator 707 converts traffic and/or control information received from the controller 700 in the format defined by the IEEE 802.11 standard and sends the converted traffic and/or control information to the IEEE 802.11 network interface 705.

The IEEE 802.16 network interface 708 interfaces with the IEEE 802.16 network. The third message analyzer 709 analyzes an IEEE 802.16 message received from the IEEE 802.16 network interface 708 and provides the message to the controller 700. The third message generator 710 converts traffic and/or control information received from the controller 700 in the format defined by the IEEE 802.16 standard and sends the converted traffic and/or control information to the IEEE 802.16 network interface 708.

The controller 700 provides overall control to the operation of the handoff processing entity 530. Particularly, it controls conversion of QoS information for a source network to QoS information for a target network during IEEE 802.11-IEEE 802.16 vertical handoff in the present invention. The memory 701 stores programs for controlling the overall operation of the handoff processing entity 530, parameters, and temporary data generated during the operation of the handoff processing entity 530. Particularly the memory 701 preserves a QoS mapping table 711 for mapping different QoS information for heterogeneous networks to each other.

For example, in the case of an IEEE 802.16 to IEEE 802.11 vertical handoff, the controller 700 converts IEEE 802.16 QoS information (QoS parameters) acquired by the third message analyzer 709 to IEEE 802.11 QoS information, referring to the QoS mapping table 711 and sends the converted QoS information to the second message generator 707. The second message generator 707 generates an IEEE 802.11 message including the QoS information and sends the message to the IEEE 802.11 network. Since the handoff processing entity 530 converts QoS information for a source network to QoS information for a target network and sends the converted QoS information, vertical handoff can be implemented, taking into account QoS in the present invention.

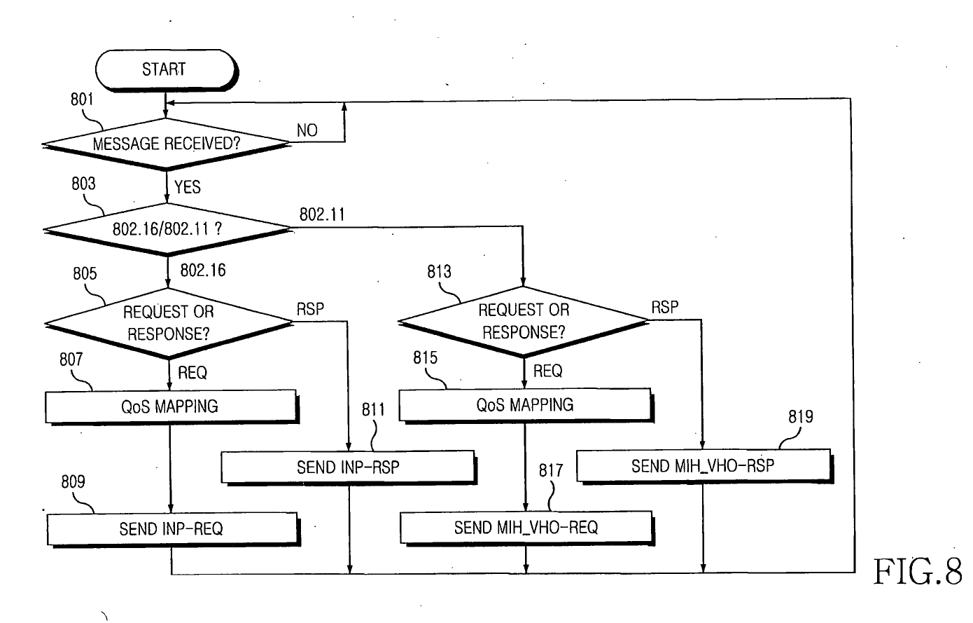

FIG. 8 is a flowchart illustrating a handoff procedure in the handoff processing entity 530 according to the present invention.

Referring to FIG. 8, the controller 700 monitors message reception in step 801. Upon receipt of a message, the controller 700 determines which network the message is from in step 803.

If the message is from the IEEE 802.16 network, the controller 700 checks the type of the received message in step 805. When a message is received at the handoff processing entity 530, a corresponding message analyzer 703, 706 or 709 analyzes the received message and sends header information and payload to the controller 700. The controller 700 then checks the type of the message from the received information and correspondingly processes the message.

If the message type indicates an MIH_VHO-REQ message requesting a handoff from the IEEE 802.16 network, the controller 700 converts IEEE 802.16 QoS information extracted from the MIH_VHO-REQ message to IEEE 802.11 QoS information, referring to the QoS mapping table 711 in step 807. In step 809, the controller 700 generates an Inter-Network Protocol (INP)-REQ message containing the IEEE 802.11 QoS information and sends the INP-REQ message to an AP in the IEEE 802.11 network. Then the controller 700 returns to step 801.

On the other hand, if the message type indicates an MIH_VHO-RSP message from the IEEE 802.16 network in step 805, the controller 700 generates an INP-RSP message for the INP-REQ message and sends the INP-RSP message to the IEEE 802.11 AP in step 811. The INP-RSP message contains access information (e.g. initial ranging information) for the IEEE 802.16 network. The controller 700 then returns to step 801.

In case of receiving a message from the IEEE 802.11 network in step 803, the controller 700 checks the type of the received message in step 813. If the received message is an INP-REQ message from the IEEE 802.11 network, requesting a handoff, the controller 700 converts IEEE 802.11 QoS information to IEEE 802.16 QoS information, referring to the QoS mapping table 711 in step 815 and sends an MIH_VHO-REQ message containing the IEEE 802.16 QoS information to the BS in step 817. Then the controller 700 returns to step 801.

If the received message is an INP-RSP message from the IEEE 802.11 network, the controller 700 generates an MIH_VHO-RSP message for the MIH_VHO-REQ message of the IEEE 802.16 network and sends the MIH_VHO-RSP message to the BS in step 819. The BS releases a connection from the STA which hands over to the IEEE 802.11 network, and the controller 700 returns to step 801.

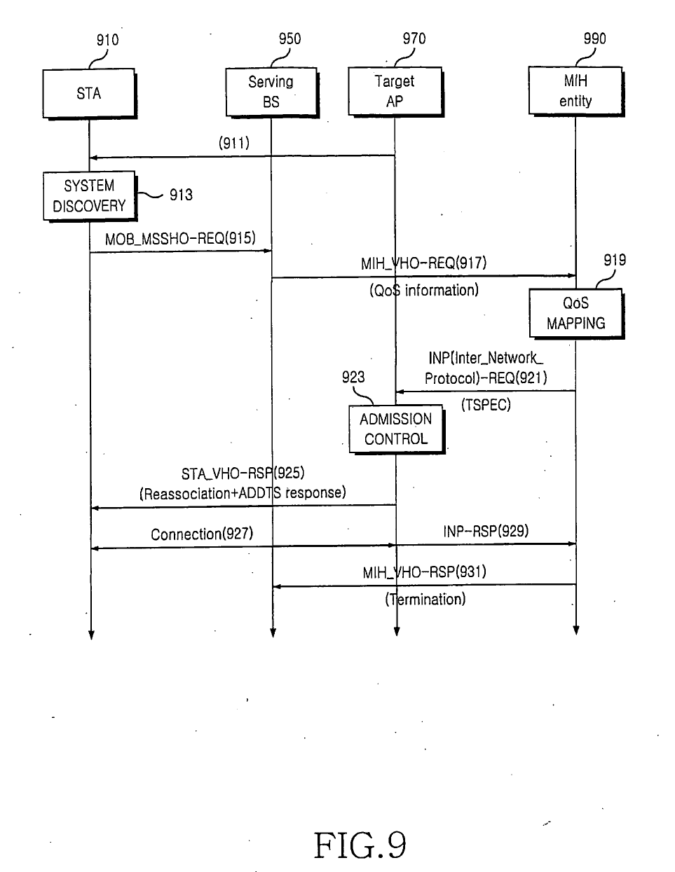

FIG. 9 is a diagram illustrating a signal flow for the vertical handoff from the broadband wireless network to the WLAN according to the present invention. An STA 910 hands over from an IEEE 802.16 BS 950 to an IEEE 802.11 AP 970.

The STA 910 connected to the BS 950 detects a neighbor AP 970 by scanning in step 911 and decides on a vertical handoff by a predetermined system discovery algorithm in step 913.

In step 915, the STA 910 sends a MOB_MSSHO-REQ message based on IEEE 802.16 to the BS 950. The target of the handoff is set as the AP 970. The BS 950 forwards the MIH_VHO-REQ message to a handoff processing entity 990 (i.e. an MIH entity 990) in step 917. According to the present invention, the MIH_VHO-REQ message contains IEEE 802.16 QoS information about all traffic being serviced to the STA910.

The MIH_VHO-REQ message is defined in Table 11 below.

TABLE 11

| Information | Notes |
|---|---|
| Message Type | Message ID |
| System Address | Address of serving or target AP/BS |
| STA Address | Address of handoff STA |
| QoS information | QoS of all traffic being serviced to STA |

In step 919, the handoff processing entity 990 converts the IEEE 802.16 QoS information contained in the MIH_VHO-REQ message to IEEE 802.11 QOS information, referring to the QoS mapping table.

The handoff processing entity 990 generates an INP-REQ message containing the IEEE 802.11 QoS information and sends the INP-REQ message to the target AP 970 in step 921. INP messages are exchanged between the AP 970 and the handoff processing entity 990, and may be based on the IEEE 802.11f standard, for example. The INP-REQ message has the following format as shown in Table 12:

TABLE 12

| Information | Notes |
|---|---|
| Message Type | Message ID |
| System Address | Address of serving or target AP/BS |
| STA Address | Address of handoff STA |
| QoS information | QoS of all traffic being serviced to STA |

The AP 970 performs an admission control operation for the STA 910 using the QoS information extracted from the INP-REQ message in step 923. If the STA 910 can be admitted, the AP 970 sends an STA_VHO-RSP message to the STA 910 in order to establish a connection in step 925.

The STA_VHO-RSP message is a combination of an IEEE 802.11 Reassociation Response message and an IEEE 802.11 ADDTS response message. The STA_VHO-RSP message contains an association ID for connection setup and a status code for session setup. The STA_VHO-RSP message can be configured in compliance with the IEEE 802.11e standard and have the following information as shown in Table 13.

TABLE 13

| Information | Notes |
|---|---|
| Capability Information | Includes number of subfields used to |
| | indicate request or advertised capabilities |
| Association ID | Value generated in AP during association |
| | to indicate the ID of STA |
| Supported Rates | Rates that STA is capable of receiving in |
| | Operational Rate Set as described in |
| | MLME_Join.request and |
| | MLME_Start.request primitives |
| Category | Set to 1 to indicate QoS |
| Action | Set to 0 to indicate ADDTS request |
| Dialog Token | TSPEC parameter provided by MLME |
| Status Code | ADDTS information |
| TS delay | Waiting time before TS reinitiation |
| TSPEC | |
| TCLAS (optional) | TSPEC parameter provided by MLME |
| TCLAS processing (optional) | TSPEC parameter provided by MLME |
| Schedule | Service start time and interval |
| IEEE 802.16 BS | UCD and initial ranging period |
| Transmission Parameter | information |
| | (in case of handoff to IEEE 802.16 |
| | network) |

In step 927, the STA 910 establishes a connection with the AP 970 based on the information of the STA_VHO-RSP message. The AP 970 replies with an INP-RSP message for the INP-REQ message to the handoff processing entity 990 in step 929.

The INP-RSP message is defined in Table 14.

TABLE 14

| Information | Notes |
|---|---|
| Message Type | Message ID |
| System Address | Address of serving or target AP/BS |
| STA Address | Address of handoff STA |
| IEEE 802.16 BS | UCD and initial ranging period |
| Transmission Parameter | information |
| | (in case of handoff to IEEE 802.16 |
| | network) |

In step 931, the handoff processing entity 990 sends an MIH_VHO-RSP message to the serving BS 950, notifying of completion of the handoff. Thus, the connection between the STA 910 and the BS 950 is released. The MIH_VHO-RSP message is defined in Table 15.

TABLE 15

| Information | Notes |
|---|---|
| Message Type | Message ID |
| System Address | Address of serving or target AP/BS |
| STA Address | Address of handoff STA |
| 802.16 BS Transmission | UCD and initial ranging period |
| Parameter | information |

While the single STA_VHO-RSP message equivalent to a combination of a Reassociation response message and an ADDTS response is sent to the STA in step 925 in the above embodiment of the present invention, it can be further contemplated that the Reassociation response message and the ADDTS response defined by IEEE 802.11 are sent separately to the STA. In the latter case, the STA does not need to interpret the new message, which makes it possible to apply the present invention without any modification to the protocol of the STA.

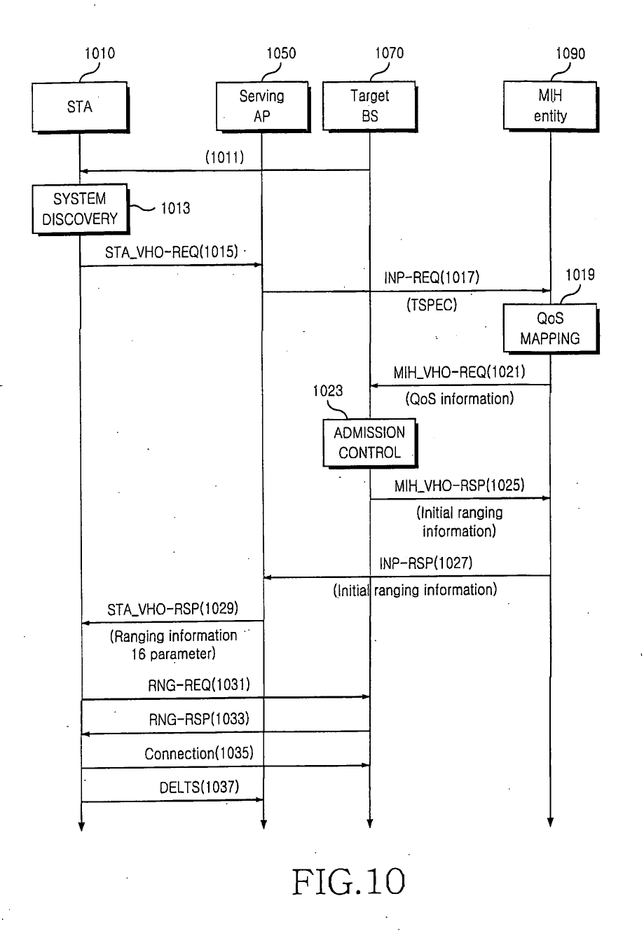

FIG. 10 is a diagram illustrating a signal flow for a vertical handoff from the WLAN to the broadband wireless network according to the present invention. An STA 1010 performs a vertical handoff from an IEEE 802.11 AP 1050 to an IEEE 802.11 BS 1070.

Referring to FIG. 10, the STA 1010 connected to the AP 1050 detects a neighbor BS 1070 by scanning in step 1011 and decides on a vertical handoff by a predetermined system discovery algorithm in step 1013.

In step 1015, the STA 1010 sends an STA_VHO-REQ message to the AP 1050.

The STA_VHO-REQ message is defined in Table 16 below.

TABLE 16

| Information | Notes |
|---|---|
| Message Type | Message ID |
| STA Address | Address of handoff STA |
| QoS information | QoS of all traffic being serviced to STA |

In step 1017, the AP 1050 generates an INP-REQ message including QoS information about all traffic being serviced to the STA 1010 and sends the INP-REQ message to a handoff processing entity (MIH entity) 1090. The INP-REQ message has the format illustrated in Table 12.

The handoff processing entity 1090 converts IEEE 802.11 QoS information contained in the INP-REQ message to IEEE 802.16 QoS information, referring to the QoS mapping table in step 1019. The handoff processing entity 1090 generates an MIH_VHO-REQ message containing the IEEE 802.16 QoS information and sends the MIH_VHO-REQ message to the target BS 1070 in step 1021. The MIH_VHO-REQ message is configured as illustrated in Table 11.

The BS 1070 performs an admission control operation for the STA 1010 using the QoS information extracted from the MIH_VHO-REQ message in step 1023. If the STA 1010 can be admitted, the BS 1070 sends an MIH_VHO-RSP message to the handoff processing entity 1090 in step 1025. The MIH_VHO-RSP message is defined in Table 15.

In step 1027, the handoff processing entity 1090 converts the MIH_VHO-RSP message to an INP-RSP message and sends the INP-RSP message to the serving AP 1050. The INP-RSP message is defined in Table 14.

In step 1029, the AP 1050 acquires IEEE 802.16 BS transmission parameters (e.g. USD, initial ranging period information, etc.) and sends an STA_VHO-RSP message containing the transmission parameters to the STA 1010. The STA-VHO-RSP message is defined in Table 13.

The STA 1010 acquires the BS access information (e.g. USD, initial ranging period information, etc.) from the STA_VHO-RSP message and is connected to the BS 1070 based on the BS access information in steps 1031, 1033 and 1035. After the connection setup, the STA 1010 releases a TS from the AP 1050 by sending a DELTS (TS Deleting) message to the AP 1050 in step 1037.

While after the handoff, the STA 1010 releases a connection from the old AP 1050 by sending the DELTS message in the above embodiment, it may not send the DELTS message in another embodiment of the present invention. In the latter case, the AP 1050 automatically releases the TS from the STA 1010 if the STA 1010 does not signal for a predetermined time. Also, while the DELTS message is sent to the AP after the connection setup with the BS 1070 in the above embodiment, it may be sent before the connection setup, after the STA_VHO-RSP message is received.

As described above, the present invention provides a technique for performing vertical handoff between an IEEE 802.11 WLAN and an IEEE 802.16 broadband wireless system. The vertical handoff is supported, taking into account QoS between the two networks and consequently, a vertical handoff can be performed efficiently in a network with the IEEE 802.11 and IEEE 802.16 networks coexisting therein.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A method of processing a vertical handoff in a handoff processor having a mapping table in which Quality of Service (QoS) information for a broadband wireless communication network is mapped to QoS information for a Wireless Local Area Network (WLAN), comprising the steps of:
converting QoS information about a station (STA) received from a source network to QoS information suitable for a target network, referring to the mapping table; and
generating a message containing the converted QoS information and sending the message to the target network.

2. A method of processing a vertical handoff in a handoff processor having a mapping table in which Quality of Service (QoS) information for a wireless communication network is mapped to QoS information for a Wireless Local Area Network (WLAN), comprising the steps of:
acquiring QoS information from a vertical handoff request message, upon receipt of the vertical handoff request message from a Base Station (BS) of the broadband wireless communication network;
converting the acquired QoS information to QoS information for the WLAN, referring to the mapping table; and
generating a request message containing the converted QoS information and sending the request message to an Access Point (AP) of the WLAN.

3. The method of claim 2, further comprising, upon receipt of a response message for the request message, sending a vertical handoff response message indicating handoff completion to the BS.

4. A method of processing a vertical handoff in a handoff processor having a mapping table in which Quality of Service (QoS) information for a broadband wireless communication network is mapped to QoS information for a Wireless Local Area Network (WLAN), comprising the steps of:
acquiring QoS information from a vertical handoff request message, upon receipt of the vertical handoff request message from an Access Point (AP) of the WLAN;
converting the acquired QoS information to QoS information for the broadband wireless communication network, referring to the mapping table; and
generating a request message containing the converted QoS information and sending the request message to a Base Station (BS) of the broadband wireless communication network.

5. The method of claim 4, further comprising:
acquiring, upon receipt of a response message for the request message, BS access information from the response message; and
sending a vertical handoff response message including the acquired BS access information to the AP.

6. The method of claim 5, wherein the BS access information includes initial ranging information.

7. A method of processing a vertical handoff in an Access Point (AP) in a wireless communication system having a handoff processor for supporting handoff between a Wireless Local Area Network (WLAN) and a broadband wireless communication network, comprising the steps of:
generating, upon receipt of a vertical handoff request message from a station (STA), a request message including Quality of Service (QoS) information about the STA and sending the vertical handoff request message to the handoff processor;
acquiring, upon receipt of a response message for the request message from the handoff processor, BS access information from the response message; and
sending a vertical handoff response message including the acquired BS access information to the STA.

8. The method of claim 7, wherein the BS access information includes initial ranging information.

9. A method of processing a vertical handoff in an Access Point (AP) in a wireless communication system having a handoff processor for supporting handoff between a Wireless Local Area Network (WLAN) and a broadband wireless communication network, comprising the steps of:
receiving a request message including Quality of Service (QoS) information about a station (STA) which is to hand over from a Base Station (BS) of the broadband wireless communication network to the AP from the handoff processor;
performing an admission control using the QoS information acquired from the request message; and
sending a connection setup message for setting up a connection with the STA to the STA, if it is determined that the STA is admitted.

10. The method of claim 9, wherein the connection setup message includes a reassociation response and an add Traffic Stream (TS) response.

11. The method of claim 9, wherein the connection setup message is a reassociation response message and an add TS response message.

12. The method of claim 9, further comprising sending a response message for the request message to the handoff processor, after sending the connection setup message to the STA.

13. A method of processing a vertical handoff in a Base Station (BS) in a wireless communication system having a handoff processor for supporting handoff between a Wireless Local Area Network (WLAN) and a broadband wireless communication network, comprising the steps of:
receiving a request message including Quality of Service (QoS) information about a station (STA) which is to hand over from an Access Point (AP) of the WLAN to the BS from the handoff processor;
performing an admission control using the QoS information acquired from the request message; and
generating a message including BS access information and sending the message to the handoff processor, if it is determined that the STA is admitted.

14. The method of claim 13, wherein the BS access information includes initial ranging information.

15. The method of claim 13, further comprising:
generating a message including the QoS information of the STA, upon receipt of a vertical handoff request message from the STA and sending the message to the handoff processor;
releasing a connection from the STA, upon receipt of a response message for the vertical handoff request message from the handoff processor.

16. A method of processing a vertical handoff in a station (STA) connected to an Access Point (AP) in a wireless communication system having a handoff processor for supporting handoff between a Wireless Local Area Network (WLAN) and a broadband wireless communication network, comprising the steps of:
acquiring a signal from a neighbor Base Station (BS) by scanning;
determining whether to perform a vertical handoff based on the signal from the BS;
sending a vertical handoff request message to the AP, if it is determined that the vertical handoff is to be performed; and
connecting to the BS using BS access information, upon receipt of a message including the BS access information from the AP.

17. The method of claim 16, further comprising sending a message for releasing a connection to the AP, after connecting to the BS.

18. A method of processing a vertical handoff in a station (STA) connected to a Base Station (BS) in a wireless communication system having a handoff processor for supporting handoff between a Wireless Local Area Network (WLAN) and a broadband wireless communication network, comprising the steps of:
acquiring a signal from a neighbor Access Point (AP) by scanning;
determining whether to perform a vertical handoff based on the signal from the AP;
sending a vertical handoff request message to the BS, if it is determined that the vertical handoff is to be performed; and
connecting to the AP, upon receipt of a connection setup message from the AP.

19. The method of claim 18, wherein the connection setup message includes a reassociation response and an add Traffic Stream (TS) response.

20. The method of claim 18, wherein the connection setup message is a reassociation response message and an add TS response message.

21. An apparatus for processing a vertical handoff between a Wireless Local Area Network (WLAN) and a broadband wireless communication network, comprising:
a memory having a mapping table in which Quality of Service (QoS) information for the broadband wireless communication network is mapped to QoS information for the WLAN; and
a controller for converting QoS information about a station (STA) received from a source network to QoS information for a target network, referring to the mapping table, during a vertical handoff of the STA.

22. The apparatus of claim 21, further comprising a message processor for extracting QoS information from a message received from the source network, sending the QoS information to the controller, generating a message including QoS information for the target network received from the controller, and sending the message to the target network.

23. The apparatus of claim 21, wherein the broadband wireless communication network is based on Institute of Electrical and Electronics Engineers (IEEE) 802.16 standard.

24. The apparatus of claim 21, wherein the QoS information for the WLAN is a traffic specification (TSPEC).

25. A method of processing a vertical handoff between different networks, comprising the steps of:
converting QoS information about a station (STA) received from a source network to QoS information suitable for a target network, referring to the mapping table; and
generating a message containing the converted QoS information and sending the message to the target network.

26. A method of processing a vertical handoff between different networks, comprising the steps of:
acquiring QoS information from a vertical handoff request message, upon receipt of the vertical handoff request message from a Base Station (BS) of the broadband wireless communication network;
converting the acquired QoS information to QoS information for the WLAN, referring to the mapping table; and
generating a request message containing the converted QoS information and sending the request message to an Access Point (AP) of the WLAN.

27. A method of processing a vertical handoff between different networks, comprising the steps of:
acquiring QoS information from a vertical handoff request message, upon receipt of the vertical handoff request message from an Access Point (AP) of the WLAN;
converting the acquired QoS information to QoS information for the broadband wireless communication network, referring to the mapping table; and
generating a request message containing the converted QoS information and sending the request message to a Base Station (BS) of the broadband wireless communication network.

28. A method of processing a vertical handoff between different networks, comprising the steps of:
generating, upon receipt of a vertical handoff request message from a station (STA), a request message including Quality of Service (QoS) information about the STA and sending the vertical handoff request message to the handoff processor;
acquiring, upon receipt of a response message for the request message from the handoff processor, BS access information from the response message; and
sending a vertical handoff response message including the acquired BS access information to the STA.

29. A method of processing a vertical handoff between different networks, comprising the steps of:
receiving a request message including Quality of Service (QoS) information about a station (STA) which is to hand over from a Base Station (BS) of the broadband wireless communication network to the AP from the handoff processor;
performing an admission control using the QoS information acquired from the request message; and
sending a connection setup message for setting up a connection with the STA to the STA, if it is determined that the STA is admitted.

30. A method of processing a vertical handoff between different networks, comprising the steps of:
receiving a request message including Quality of Service (QoS) information about a station (STA) which is to hand over from an Access Point (AP) of the WLAN to the BS from the handoff processor;
performing an admission control using the QoS information acquired from the request message; and
generating a message including BS access information and sending the message to the handoff processor, if it is determined that the STA is admitted.

31. A method of processing a vertical handoff between different networks, comprising the steps of:
acquiring a signal from a neighbor Base Station (BS) by scanning;
determining whether to perform a vertical handoff based on the signal from the BS;
sending a vertical handoff request message to the AP, if it is determined that the vertical handoff is to be performed; and
connecting to the BS using BS access information, upon receipt of a message including the BS access information from the AP.

32. A method of processing a vertical handoff between different networks, comprising the steps of:
acquiring a signal from a neighbor Access Point (AP) by scanning;
determining whether to perform a vertical handoff based on the signal from the AP;
sending a vertical handoff request message to the BS, if it is determined that the vertical handoff is to be performed; and
connecting to the AP, upon receipt of a connection setup message from the AP.

33. An apparatus for processing a vertical handoff between a first network and a second network, comprising:
a memory having a mapping table in which Quality of Service (QoS) information for the first network is mapped to QoS information for the second network; and
a controller for converting QoS information about a station (STA) received from a source network to QoS information for a target network, referring to the mapping table, during a vertical handoff of the STA.
